(19) United States
(12) Patent Application Publication
(10) Pub. No.: US 2010/0117966 A1
(43) Pub. Date: May 13, 2010

(54) KEYBOARD CONTROL MEANS

(76) Inventor: James W. Burrell, IV, Union, NJ (US)

Correspondence Address: Ezra Sutton, P.A., Suite 201, Plaza 9, 900 Route 9, Woodbridge, NJ, 07095-1024, US

(21) Appl. No.: 12/268,612

(22) Filed: Nov. 11, 2008

(51) Int. Cl. G06F 3/02

(52) U.S. Cl. 345/168

(57) ABSTRACT

This invention relates to methods of using a sensor or sensors on an input device to produce a data character, control or function by activating a sensor once and to produce a second programmed data character, control or function by activating said same sensor once for a longer preset length of time. Moving a sensor on an input device in one direction produces a data character, control or function and moving said same sensor in said same direction and holding said same sensor in said same direction for a preset length of time produces a second programmed data character, control or function. Moving said same sensor in said same direction and then activating said same sensor in a downward direction or activating said same sensor in a downward direction for a preset length of time also produces a second programmed data character, control or function. Sequentially activating a sensor more than once produces a data character, control or function and sequentially activating said same sensor more than once where the last activation is activated for a longer preset length of time produces a data character, control or function. Simultaneously activating sensors once produces a data character, control or function and simultaneously activating said same sensors once for a longer preset length of time produces a data character, control or function producing a second programmed data character, control or function. Non-activation of a sensor for a preset length of time produces the “Enter” function.

### RELATED APPLICATIONS

The invention described in this patent application is an enhancement to and for use with U.S. Pat. No. 5,993,089 issued Nov. 20, 1999, titled “8-bit Binary Code for Use as an 8-dot Braille Arrangement and Data Entry System and Method for 8-key Chordic Binary Keyboards”, U.S. Pat. No. 6,043,761 issued Mar. 28, 2000, titled “Method of Using a Nine Key Alphanumeric Binary Keyboard Combined with a Three Key Keyboard Control Keyboard”, U.S. Pat. No. 6,184,803 issued on Feb. 6, 2001, titled “Nine Key Alphanumeric Binary Keyboard Combined with a Three Key Keyboard Control Keyboard and Combinational Control Means”, U.S. Pat. No. 6,232,892 issued on May 15, 2001, titled “Method of Using a Nine Key Alphanumeric Binary Keyboard Combined with a Three Key Keyboard Control Keyboard”, U.S. Pat. No. 7,160,042 issued Jan. 9, 2007, titled “Two Sensor Movement”, U.S. patent application Ser. No. 11/083,752 filed Mar. 18, 2005, titled “Hand Held Communications Computer and Keyboard”, U.S. patent application Ser. No. 11,811,226 filed Jun. 7, 2007, titled “Four Sensor Control”, U.S. CIP patent application Ser. No. 11,780,655 filed Jul. 20, 2007, titled “Four Sensor Control”, U.S. patent application Ser. No. 12/202,702 filed Sep. 2, 2009, titled “Nine Sensor Data Entry Keyboard and Control Means”, U.S. patent application Ser. No. 12/235,984 filed Sep. 23, 2008, titled “World's Smallest Keyboard and Control Means”, all to Burrell, IV and other prior art devices.

### FIELD OF THE INVENTION

The present invention relates to a method of using a sensor or sensors on an input device for producing a first set of data characters, control or functions by activating a sensor or sensors individually, sequentially or simultaneously and for producing a second set of programmed data characters, control or functions by activating said same sensor or said same sensors individually, sequentially or simultaneously for a longer preset length of time. Non-activation of a sensor or sensors for a preset length of time produces the “Enter” function.

### BACKGROUND OF THE INVENTION

The first alphanumeric data producing keyboards were modified piano keyboards. Since the development of the data entry keyboard more than a hundred years ago, alphabetic characters, numbers, a space, punctuation, symbols, etc. were each produced on individual keys. Uppercase capital letters were produced using the letter key and a shift key. Attempts to reduce the keyboard's size and the number of sensors used to produce alphanumeric data required using keyboards where each key produces more than one data character. The least amount of sensors used to produce alphanumeric data in recognized prior art uses seven sensors (braille typewriter), eight sensors (8-dot braille typewriter) or twelve sensors (phone keypad). There have also been less known keyboards using five and ten sensors.

The present invention has been designed to work on other prior art inventions and the inventor's prior inventions, including but not limited to; U.S. Pat. No. 6,043,761, U.S. Pat. No. 6,184,803, U.S. Pat. No. 6,232,892, U.S. Pat. No. 7,160,042, U.S. patent application Ser. No. 11/083,752, U.S. patent application Ser. No. 11,811,226, U.S. CIP patent application Ser. No. 11,780,655, U.S. patent application Ser. No. 12/202,702, U.S. patent application Ser. No. 12/235,984, all to Burrell, IV described in the previous related applications section and other prior art inventions.

The present invention can also work on any electronic braille transcription device, any computer keyboard, any touch screen keyboard, any keyboard that has a reduced amount of keys, etc.

The most well known prior art using the activation of a sensor for a preset or programmed duration of time is the FilterKeys function found in the Accessibility Options of the Control Panel in the computer's operating system. Activating a sensor for a preset or programmed duration of time produces a Repeat Keys function, where after usually one second the activated key produces the key's data character continuously.

Text messaging on a cell phone is a prior art technology that uses a multi-tap method of data entry to produce the alphabet using eight keys. Three letters are assigned to each key and the seven [7] key has the additional letter “Q” and the nine [9] key has the additional letter “Z”. Pressing a key once produces a first data character, twice produces a second data character and three times produces a third data character. If the key has four letters on it, pressing the same key produces a fourth data character. The space is usually produced on the zero [0] key or on the asterisk [*] key. To produce a capital letter, a non-alphabet labeled key is used, usually the pound sign [#] key is used. Numbers are produced using the numbered keys one[1] through nine [9] and the zero [0] key. Punctuation is produced using the one [1] key. The present invention allows the text messaging user to produce a capital letter by holding down the alphabetic data entered key for a preset length of time.

Many solutions to improve many of the existing prior art problems have been made, but many are not well suited for the blind community, the deaf-blind community and for an individual needing to enter alphabetic data into a data entry device without looking at the input device keyboard. A method of data entry using a keyboard which does not require visual assistance and/or a reduction in keyboard size and efficiency is needed. The invention disclosed in this patent application fulfills these needs.

### SUMMARY OF THE INVENTION

The present invention includes a method of using a sensor or sensors on an input device to produce a data character, control or function by activating a sensor once and to produce a second programmed data character, control or function by activating said same sensor once for a longer preset length of time.

The present invention also includes a method of moving a sensor on an input device in one direction to produce a data character, control or function and moving said same sensor in said same direction and holding said same sensor in said same direction for a preset length of time to produce a second programmed data character, control or function. Moving said same sensor in said same direction and then activating said same sensor in a downward direction or activating said same sensor in a downward direction for a preset length of time produces a second programmed data character, control or function.

The present invention also includes a method of using a sensor or sensors on an input device to produce a data character, control or function by sequentially activating a sensor more than once and producing a second programmed data character, control or function by sequentially activating said same sensor more than once and the last activation is activated for a longer preset length of time.

The present invention also includes a method of using sensors on an input device to produce a data character, control or function by simultaneously activating said sensors once and producing a second programmed data character, control or function by simultaneously activating said same sensors once for longer preset length of time.

Non-activation of a sensor for a preset length of time produces the “Enter” function.

The present invention provides a method of using a keyboard or input device for producing a first set of alphabetic data characters, data characters, a space, numbers, punctuation, symbols, control and functions and a second set of alphabetic data characters, data characters, numbers, punctuation, symbols, control and functions. Activating any sensor or sensors one or more times produces a first type of data and activating said same sensor or sensors one or more times for a longer preset length of time produces a second type of data.

Activating a sensor eight times or more produces even more data characters, control or functions. Programming the device to produce the user's preferred data characters using preferred key activations is also possible. After activating a sensor or sensors individually, sequentially or simultaneously for a preset duration of time, the present invention enters the desired data and allows for the entering of the next data character, control or function.

The present invention allows the shift function to be programmed into a keyboard device by activating a sensor for a longer preset length of time. Prior art and present computer keyboards produce a character repeat function when a sensor is activated for a longer preset length of time.

Braille transcribers can hold down a braille chord on an electronic braille transcription device for as long as they like without producing a braille character repeat function. To produce a capital braille letter the braille transcriber must type the capital braille sign first before typing the braille letter. The present invention allows the braille transcriber the ability to type the braille letter and hold down the braille chord for a longer preset length of time for producing the shift function and a capital braille letter.

It is an object of the present invention to provide a keyboard wherein activating a sensor produces some form of data and activating said same sensor for a preset longer duration of time produces some other form of data.

It is another object of the present invention to provide a keyboard wherein moving a sensor in one direction produces some form of data and moving said same sensor in said same direction for a preset longer duration of time produces some other form of data.

It is still another object of the present invention to provide a keyboard wherein activating a sensor multiple times produces some form of data and activating said same sensor said same amount of times, where the last sensor activation is for a longer preset duration of time, to produce some other form of data.

It is yet another object of the present invention to provide a keyboard wherein non-activation of a sensor or sensors, for a preset duration of time, produces the enter function after completing the input of data.

It is a further object of the present invention to provide a chordic keyboard wherein the shift function is produced when a sensor or combination of sensors is activated for a longer preset duration of time

These and other objects, features and advantages of the present invention are provided within this patent application and will be better understood in connection with the following drawings and descriptions of the preferred embodiments. Additional objects and applications of the present invention will become apparent as the description proceeds.

It is to be understood that the present invention is not limited in its application to the details of construction and to the arrangements of the components set forth in the following description or illustrated in the drawings. The present invention is capable of other embodiments and of being practiced and carried out in various ways. It should be also understood that the phraseology and terminology used in this patent application are for the purpose of describing and claiming the present invention and should not be regarded as limiting.

### DESCRIPTION OF THE DRAWINGS

For a better understanding of the invention as well as other objects, features and advantages thereof, reference is made to the following detailed description to be read in conjunction with the accompanying drawings, wherein:

FIG. 1 shows a top view of the present invention, depicting a nine sensor keyboard where a centrally located sensor is surrounded by a octagon shaped sensor with an octagonal shaped interior and eight surfaces for activation in eight cardinal point directions. Each of the nine sensors is numbered one through nine using the standard phone keypad numbering arrangement allowing for the placement of additional characters. Each of the nine sensors is labeled with three of twenty-six alphabetic characters and a space. Each of the nine sensors is also labeled with three punctuation marks or symbols. The sensor numbered one is labeled with the space and two alphabetic characters. Three additional sensors are labeled with the asterisk, zero and number sign. The zero sensor also is also labeled with three punctuation marks or symbols.

FIG. 2 shows a top view of one embodiment of the present invention using the prior art iPod menu key depicting a nine sensor keyboard where a centrally located sensor is surrounded by a disc shaped sensor with an eight surfaces for activation in eight cardinal point directions. Each of the nine sensors is numbered one through nine using the standard phone keypad numbering arrangement allowing for the placement of additional characters. Each of the nine sensors is labeled with three of twenty-six alphabetic characters and a space. The sensor numbered one is labeled with the space and two alphabetic characters. Each of the nine sensors is also labeled with three punctuation marks or symbols.

A multitude of figure drawings, prior art and descriptions of alternative embodiments of the present invention have been left out of the present patent application. The following description of some preferred embodiments, will allow one skilled in the art to realize the countless applications of the present invention.

### DETAILED DESCRIPTION OF THE PREFERRED EMBODIMENT

In order too more fully understand the invention, during the course of this description, a nine sensor keyboard will be labeled and explained to easily identify like elements according to the different figures which illustrate the invention. Additional objects of the present invention will become apparent as the description proceeds.

When any device is in the data entry mode, the present invention produces letters or characters, a space, numbers, punctuation, symbols, control and functions using activation of one or more sensors individually, sequentially or simultaneously. On some devices, activating a sensors once produces the desired data. On other devices, activating a sensors once, twice, thrice, etc. produces the desired data. On chordic data entry devices, activating a combinations of sensors produces the desired data. The present invention can be used on computer keyboards, phone keypads, phone menu keys, camera menu sensors, iPod and MP3 menu keys, keyboards with a limited amount of sensors to produce data, chordic keyboards and other data entry devices.

One embodiment of the present invention includes:

A method of using a keyboard for producing alphabetic data characters, data characters, a space, numbers, punctuation, symbols, control and functions. Activating any sensor or sensors individually, sequentially or simultaneously produces a first data character and activating said same sensor or sensors individually, sequentially or simultaneously for a longer preset length of time produces a second data character. This feature allows the shift function to be programmed into a keyboard by activating a sensor for a longer preset length of time.

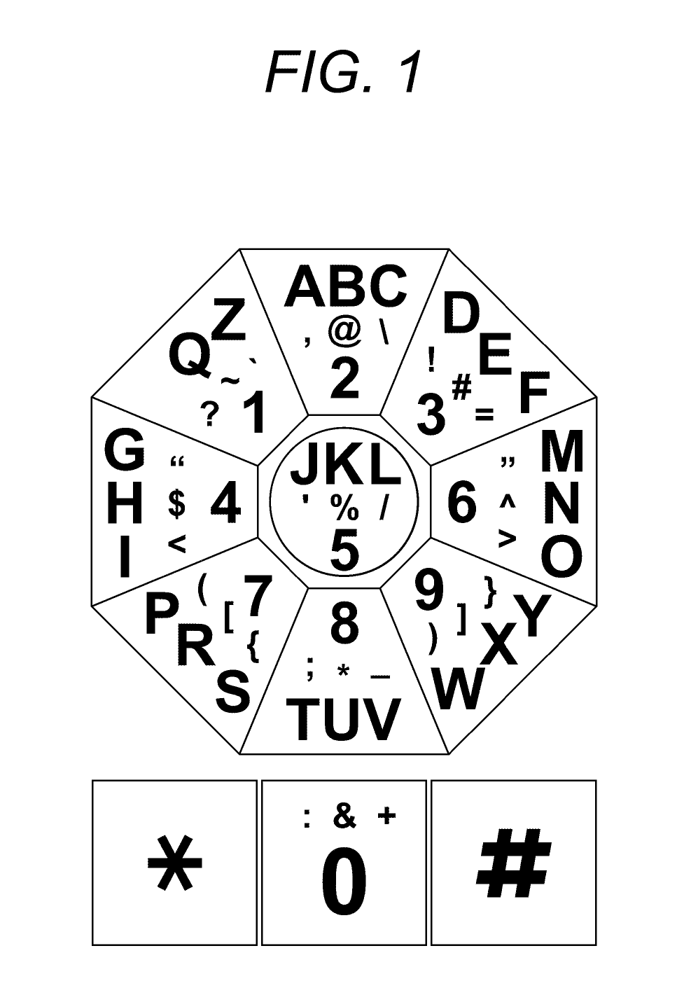

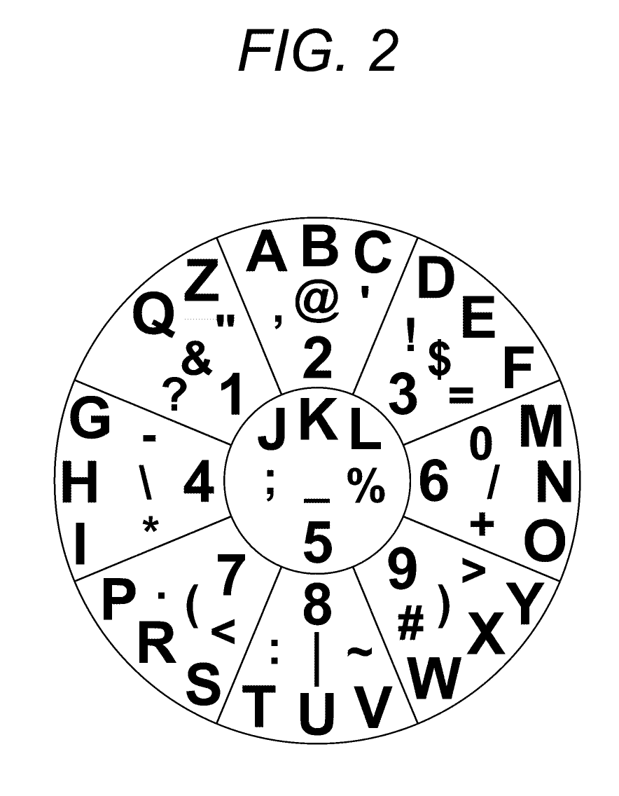

As shown in FIG. 1 and FIG. 2, one embodiment of the present invention will be described using nine sensors for producing alphabetic data characters, data characters, a space, numbers, punctuation, symbols, control and functions. Entering data using keys [1] through nine [9] and a zero [0] key into the device shown in FIG. 1, would use the present invention as a shift function to produce upper case alphabetic characters on keys [1] through nine [9].

To better understand the present invention and alternative embodiments of the present invention, the following description will use a modified iPod menu key device, as shown in FIG. 2, to explain one preferred embodiment of the present invention;

Activating and deactivating a sensor enters data into the device after said same sensor is not activated for a preset length of time.

Activating and deactivating a first sensor one or more times followed by activation of a second sensor enters the first sensor's data into the device.

Activating and deactivating a second sensor [2] once produces a lower case “a” and activating said second sensor once for a longer preset length of time produces an upper case “A”.

Activating and deactivating a second sensor [2] twice produces a lower case “b” and activating said second sensor twice for a longer preset length of time produces an upper case “B”.

Activating and deactivating a second sensor [2] thrice produces a lower case “c” and activating said second sensor thrice for a longer preset length of time produces an upper case “C”.

Activating and deactivating a third sensor [3] once produces a lower case “d” and activating said third sensor once for a longer preset length of time produces an upper case “D”.

Activating and deactivating a third sensor [3] twice produces a lower case “e” and activating said third sensor twice for a longer preset length of time produces an upper case “E”.

Activating and deactivating a third sensor [3] thrice produces a lowercase “f” and activating said third sensor thrice for a longer preset length of time produces an upper case “F”.

Activating and deactivating a fourth sensor [4] once produces a lower case “g” and activating said fourth sensor once for a longer preset length of time produces an upper case “G”.

Activating and deactivating a fourth sensor [4] twice produces a lower case “h” and activating said fourth sensor twice for a longer preset length of time produces an upper case “H”.

Activating and deactivating a fourth sensor [4] thrice produces a lower case “i” and activating said fourth sensor thrice for a longer preset length of time produces an upper case “I”.

Activating and deactivating a fifth sensor [5] once produces a lower case “j” and activating said fifth sensor once for a longer preset length of time produces an upper case “J”.

Activating and deactivating a fifth sensor [5] twice produces a lowercase “k” and activating said fifth sensor twice for a longer preset length of time produces an upper case “K”.

Activating and deactivating a fifth sensor [5] thrice produces a lower case “I” and activating said fifth sensor thrice for a longer preset length of time produces an upper case “L”.

Activating and deactivating a sixth sensor [6] once produces a lower case “m” and activating said sixth sensor once for a longer preset length of time produces an upper case “M”.

Activating and deactivating a sixth sensor [6] twice produces a lower case “n” and activating said sixth sensor twice for a longer preset length of time produces an upper case “N”.

Activating and deactivating a sixth sensor [6] thrice produces a lower case “o” and activating said sixth sensor thrice for a longer preset length of time produces an upper case “O”.

Activating and deactivating a seventh sensor [7] once produces a lower case “p” and activating said seventh sensor once for a longer preset length of time produces an upper case “P”.

Activating and deactivating a first sensor [1] twice produces a lower case “q” and activating said first sensor twice for a longer preset length of time produces an upper case “Q”.

Activating and deactivating a seventh sensor [7] twice produces a lower case “r” and activating said seventh sensor twice for a longer preset length of time produces an upper case “R”.

Activating and deactivating a seventh sensor [7] thrice produces a lower case “s” and activating said seventh sensor thrice for a longer preset length of time produces an upper case “S”.

Activating and deactivating a eighth sensor [8] once produces a lower case “t” and activating said eighth sensor once for a longer preset length of time produces an upper case “T”.

Activating and deactivating a eighth sensor [8] twice produces a lower case “u” and activating said eighth sensor twice for a longer preset length of time produces an upper case “U”.

Activating and deactivating a eighth sensor [8] thrice produces a lower case “v” and activating said eighth sensor thrice for a longer preset length of time produces an upper case “V”.

Activating and deactivating a ninth sensor [9] once produces a lower case “w” and activating said ninth sensor once for a longer preset length of time produces an upper case “W”.

Activating and deactivating a ninth sensor [9] twice produces a lower case “x” and activating said ninth sensor twice for a longer preset length of time produces an upper case “X”.

Activating and deactivating a ninth sensor [9] thrice produces a lower case “y” and activating said ninth sensor thrice for a longer preset length of time produces an upper case “Y”.

Activating and deactivating a first sensor [1] thrice produces a lower case “z” and activating said first sensor thrice for a longer preset length of time produces an upper case “Z”.

Activating and deactivating a first sensor [1] once produces a “space” and activating said first once for a longer preset length of time produces the preferred “Tab” function.

Activating and deactivating a first sensor [1] four times produces a “1”.

Activating and deactivating a second sensor [2] four times produces a “2”.
Activating and deactivating a third sensor [3] four times produces a “3”.
Activating and deactivating a fourth sensor [4] four times produces a “4”.
Activating and deactivating a fifth sensor [5] four times produces a “5”.
Activating and deactivating a sixth sensor [6] four times produces a “6”.
Activating and deactivating a seventh sensor [7] four times produces a “7”.
Activating and deactivating a eighth sensor [8] four times produces a “8”.
Activating and deactivating a ninth sensor [9] four times produces a “9”.

Activating and deactivating a first sensor [1] five times produces a question mark “?”.

Activating and deactivating a second sensor [2] five times produces a comma “,”.
Activating and deactivating a third sensor [3] five times produces an exclamation mark “!”.
Activating and deactivating a fourth sensor [4] five times produces a hyphen “-”.
Activating and deactivating a fifth sensor [5] five times produces a semicolon “;”.
Activating and deactivating a sixth sensor [6] five times produces a zero “0”.
Activating and deactivating a seventh sensor [7] five times produces a period “.”.
Activating and deactivating a eighth sensor [8] five times produces a colon “:”.
Activating and deactivating a ninth sensor [9] five times produces a number sign “#”.

Activating and deactivating a first sensor [1] six times produces an ampersand “&”.

Activating and deactivating a second sensor [2] six times produces an at sign “@”.
Activating and deactivating a third sensor [3] six times produces a dollar sign “$”.
Activating and deactivating a fourth sensor [4] six times produces a backslash “\”.
Activating and deactivating a fifth sensor [5] six times produces an underscore “_”.
Activating and deactivating a sixth sensor [6] six times produces a slash “/”.
Activating and deactivating a seventh sensor [7] six times produces a left parenthesis “(”.
Activating and deactivating a eighth sensor [8] six times produces a vertical line “|”.
Activating and deactivating a ninth sensor [9] six times produces a right parenthesis “)”.

Activating and deactivating a first sensor [1] seven times produces a quote “″”

Activating and deactivating a second sensor [2] seven times produces an apostrophe “'”.
Activating and deactivating a third sensor [3] seven times produces an equals sign “=”.
Activating and deactivating a fourth sensor [4] seven times produces an asterisk “*”.
Activating and deactivating a fifth sensor [5] seven times produces a percent sign “%”.
Activating and deactivating a sixth sensor [6] seven times produces a plus sign “+”.
Activating and deactivating a seventh sensor [7] seven times produces a less than sign “<”.
Activating and deactivating a eighth sensor [8] seven times produces a tilde “˜”.
Activating and deactivating a ninth sensor [9] seven times produces a greater than sign “>”.

Activating and deactivating a sensor eight times or more produces even more data characters, control or functions. Devices using non-English languages and data characters require the reprogramming of the device to produce the user's preferred data characters, control and functions using preferred key activations. After activating a sensor individually for a preset duration of time or multiple times for a preset duration of time, the present invention enters the desired data and allows for the entering of the next data character, control or function.

While the previous description of one preferred embodiment of the present invention has been described using nine keys on an input device, a reduction in the amount of keys on an input device or additional keys on an input device and different methods of data input do not depart from the spirit and scope of the invention as a whole. In the cell phone industry, cell phone input devices vary from device to device, but all data input devices can benefit from the invention described in this patent disclosure. Other preferred embodiments of the present invention, include but are not limited to, use: a cell phone menu key to produce data characters, control and functions; a digital camera menu key to produce data characters, control and functions; an iPod menu key to produce data characters, control and functions; a trackball with downward activation capabilities to produce data characters, control and functions; a pointing device with downward activation capabilities to produce data characters, control and functions; a computer mouse using a key on the mouse to produce data characters, control and functions; and a multitude of other data entry devices to produce data characters, control and functions.

Computer keyboards can use the present invention to produce capital letters or symbols found on the top part of keys, which require simultaneous activation with the shift key, by activating the desired key for a preset length of time.

Touch screen keyboards with limited activation zones can use the present invention to produce capital letters or other types of data by activating the desired key for a preset length of time.

Chordic keyboards can use the present invention to produce a capital letter. When using an electronic chordic keyboard Braille transcription devices, the user produces a braille chord on the device and can hold the chord for as long as they like without producing a braille character or the repeat function. To produce a capital braille letter the braille transcriber must type the capital braille sign first before typing the braille letter. The present invention allows the braille transcriber or a chordic keyboard typist the ability to type the braille letter or chord and hold down the braille or other data chord for a longer preset length of time to produce the shift function and create a capital letter or a second set of data characters, control or functions.

These and other features of the present invention will be more fully understood by referencing the drawings and the description of the invention described in this patent disclosure.

In summary, the present invention and many preferred embodiments of the present invention all use a method of producing a first predetermined set of data characters by activating and deactivating a sensor or sensors individually, sequentially or simultaneously for a preset length of time and producing a second set of data characters by activating said same sensor or sensors individually, sequentially or simultaneously for a longer preset length of time on an input device. Moving a sensor on an input device in a direction or for a preset length of time produces a first set of data characters, control or functions and moving said sensor in said same direction for a longer preset length of time produces a second set of data characters, control or functions. Activating a sensor on an input device produces a first set of data characters, control or function and enters said first set of data characters, control or function after said same sensor is not activated for a preset length of time or enters said first set of data characters, control or function after a second sensor is activated. Activating at sensor on an input device for a preset duration of time produces and enters a data character, control or function. Activating a first sensor or sensors individually, sequentially or simultaneously followed by activation of a second sensor or sensors individually, sequentially or simultaneously enters the first sensor's data entry into a data entry device.

While the present invention disclosed has been described with reference to the preferred embodiments thereof, a latitude of modification, change, and substitution is intended in the foregoing disclosure, and in some instances, some features of the invention will be employed without a corresponding use of the inventions other features. Accordingly, it will be appreciated by those having an ordinary skill in the art that various modifications can be made to the system of the invention and it is appropriate that the description and appended claims are construed broadly and in a manner consistent with the spirit and scope of the invention herein without departing from the spirit and scope of the invention as a whole.

1. A keyboard control means wherein:
a) activating and deactivating a sensor on an input device produces a data character, control or function of a first set of data characters, control or functions; and
b) continuously activating said sensor on said input device for a preset length of time produces a data character, control or function of a second set of data characters, control or functions.

2. A keyboard control means, in accordance with claim 1, wherein:
a) non-activation of said sensor on said input device, for a preset duration of time, enters said data character, control or function of said first set of data characters, control or functions; and
b) continuously activating said sensor on said input device for a preset duration of time produces and enters a data character, control or function of said second set of data characters, control or functions; and
c) activation of a second sensor on said input device enters said data character, control or function of said first set of data characters, control or functions produced by said first sensor.

3. A keyboard control means, in accordance with claim 1, wherein:
a) sequentially activating and deactivating said sensor on said input device twice produces a data character, control or function of said first set of data characters, control or functions; and
b) sequentially activating said sensor two times and maintaining activation of said sensor on said second activation for a preset length of time produces a data character, control or function of said second set of data characters, control or functions.

4. A keyboard control means, in accordance with claim 1, wherein:
a) sequentially activating and deactivating said sensor on said input device thrice produces a data character, control or function of said first set of data characters, control or functions; and
b) sequentially activating said sensor three times and maintaining activation of said sensor on said third activation for a preset length of time produces a data character, control or function of said second set of data characters, control or functions.

5. A keyboard control means, in accordance with claim 1, wherein:
a) sequentially activating and deactivating said sensor on said input device four times produces a data character, control or function of said first set of data characters, control or functions; and
b) sequentially activating said sensor three times and maintaining activation of said sensor on said fourth activation for a preset length of time produces a data character, control or function of said second set of data characters, control or functions.

6. A keyboard control means, in accordance with claim 1, wherein:
a) simultaneously activating and deactivating sensors on said input device produces a data character, control or function of said first set of data characters, control or functions; and
b) simultaneously and continuously activating said sensors on said input device for a preset length of time produces a data character, control or function of said second set of data characters, control or functions.

7. A keyboard control means, in accordance with claim 6, wherein simultaneously and continuously activating said sensors on said input device for a preset duration of time produces and enters a data character, control or function of said second set of data characters, control or functions.

8. A keyboard control means wherein:
a) moving a sensor in one direction on an input device produces a data character, control or function of a first set of data characters, control or functions; and
b) moving said sensor in said one direction on said input device and holding said sensor in said one direction for a preset length of time produces a data character, control or function of a second set of data characters, control or functions.

9. A keyboard control means, in accordance with claim 8, wherein moving said sensor in said one direction on said input device and activating said sensor in a downward direction produces a data character, control or function of said second set of data characters, control or functions.

10. A keyboard control means, in accordance with claim 8, wherein:
a) non-movement of said sensor on said input device, for a preset duration of time, enters said data character, control or function of said first set of data characters, control or functions; and
b) moving said sensor in said one direction on said input device and holding said sensor in said one direction for a preset length of time produces and enters a data character, control or function of said second set of data characters, control or functions; and
c) moving said sensor in a second direction on said input device enters said data character, control or function of said first set of data characters, control or functions produced by moving said first sensor in said one direction.

11. A keyboard control means, in accordance with claim 8, wherein:
a) sequentially moving said sensor in one direction twice on said input device produces a data character, control or function of said first set of data characters, control or functions; and
b) sequentially moving said sensor in said one direction twice on said input device and holding said sensor in said one direction on said second movement for a preset length of time produces a data character, control or function of said second set of data characters, control or functions.

12. A keyboard control means, in accordance with claim 8, wherein:
a) sequentially moving said sensor in one direction thrice on said input device produces a data character, control or function of said first set of data characters, control or functions; and
b) sequentially moving said sensor in said one direction thrice on said input device and holding said sensor in said one direction on said third movement for a preset length of time produces a data character, control or function of said second set of data characters, control or functions.

13. A keyboard control means, in accordance with claim 8, wherein:
a) sequentially moving said sensor in one direction four times on said input device produces a data character, control or function of said first set of data characters, control or functions; and
b) sequentially moving said sensor in said one direction four times on said input device and holding said sensor in said one direction on said fourth movement for a preset length of time produces a data character, control or function of said second set of data characters, control or functions.

14. A keyboard control means wherein:
a) activating and deactivating a first sensor on an input device produces a data character, control or function of a first set of data characters, control or functions; and
b) non-activation of said first sensor on said input device, for a preset duration of time, enters said data character, control or function of said first set of data characters, control or functions; and
c) activation of a second sensor on said input device enters said data character, control or function of said first set of data characters, control or functions produced by said first sensor; and
d) activating said first sensor on an input device for a preset duration of time produces and enters a data character, control or function of a second set of data characters, control or functions.
